(19) United States
(12) Patent Application Publication
(10) Pub. No.: US 2024/0356571 A1
(43) Pub. Date: Oct. 24, 2024

(54) WIRELESS WIDE AREA NETWORK RADIO SYSTEM AND APPARATUS

(71) Applicant: Nextivity, Inc., San Diego, CA (US)

(72) Inventors: Michiel Petrus Lotter, San Diego, CA (US); Edward C. Lin, San Diego, CA (US); Douglas Dromgoole, San Diego, CA (US)

(21) Appl. No.: 18/641,131

(22) Filed: Apr. 19, 2024

Related U.S. Application Data
(60) Provisional application No. 63/461,183, filed on Apr. 21, 2023.

(51) Int. Cl. H04B 1/04; H04W 52/36

(52) U.S. Cl. CPC H04B 1/04; H04W 52/367; H04B 2001/0416

(57) ABSTRACT

A wireless wide area network (WWAN) radio includes a first WWAN transceiver/MODEM configured to communicate over one or more WWANs, and a standard power port communicably coupled to the first WWAN transceiver/MODEM. The standard power port is configured as the donor path for a coupled port including a standard power port antenna and configured to transmit at a first maximum power level. The WWAN radio further includes a high-power port communicably coupled to the standard power port and configured to have a fixed gain value high power amplifier and a high power antenna, the high power port configured to transmit at a second maximum power level being greater than the first maximum power level.

### CROSS-REFERENCE TO RELATED APPLICATIONS

The present application claims priority of U.S. Provisional Application No. 63/461,183, filed Apr. 21, 2023, and entitled “WIRELESS WIDE AREA NETWORK RADIO SYSTEM AND APPARATUS”, the entirety of which is incorporated by reference herein.

### BACKGROUND

The present disclosure generally pertains to wireless communication devices, and more particularly to wireless inter-networking via wide area network radio systems and apparatuses.

A wireless wide area network (WWAN) and a wireless local area network (WLAN) are different forms of wireless networks, which generally utilize different standardized technologies. For example, a WWAN may utilize mobile telecommunication cellular network technologies, while a WLAN may utilize Wi-Fi for communications and to transfer data. A WWAN extends over a large geographical distance and typically requires fixed infrastructure such as networked cellular base stations configured to communicate to mobile handheld devices. A WLAN provides coverage within a limited area and typically uses stationary and mobile devices configured to communicate to other stationary and mobile devices. Mobile devices are typically limited by battery life, transmission power, and range, however.

Many metropolitan areas have extensive infrastructure built out to provide seamless connectivity as the mobile handheld devices travel from cell to cell of the WWAN. However, users may experience disruptions in areas that are remote, underdeveloped, have walls or other obstructions that block radio signals, and/or where infrastructures are inoperable, such as during emergencies. This can be particularly challenging for public safety first responders who regularly operate in unpredictable environments, but who nonetheless need reliable, mission-critical wireless communications for optimal performance.

In WWAN telecommunications, Long-Term Evolution (LTE) is one standard for high-speed wireless communication for mobile phones and data terminals, based on the GSM/EDGE and UMTS/HSPA technologies. The LTE standard covers a range of many different bands, each of which is designated by both a frequency and a band number. For example, Band 14 is the spectrum licensed to the First Responder Network Authority (FirstNet) to create a nationwide public-safety wireless broadband network. Band 14 represents 20 MHz of spectrum in the 700 MHz band that provides good propagation in urban and rural areas and decent penetration into buildings. However, existing standard-power broadband devices fall short in their ability to connect at long range or deeply inside large concrete buildings.

### SUMMARY

Aspects of the present disclosure include a system and method for wireless inter-networking between a wireless wide area network (WWAN) and a local area network (WLAN) employing one or more extended range wireless inter-networking devices. Aspects of the present disclosure more specifically are directed toward a high-powered wireless interconnect device that include high efficiency circuitry to make it possible to implement in a fixed, in-building, portable, or in-vehicle form factor, and which provides improved battery life, size, weight, and thermal dissipation.

In some aspects, a wireless wide area network (WWAN) radio includes a first WWAN transceiver/MODEM configured to communicate over one or more WWANs, and a standard power port communicably coupled to the first WWAN transceiver/MODEM, and configured as the donor path for a coupled port including a standard power port antenna. The standard power port is configured to transmit at a first maximum power level. The WWAN radio further includes a high power port communicably coupled to the standard power port and configured to have a fixed gain value high power amplifier and a high power antenna. The high power port is configured to transmit at a second maximum power level being greater than the first maximum power level.

In other aspects, a WWAN includes two or more WWAN radios to form a wireless local area network (WLAN).

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a wireless wide area network (WWAN) radio in accordance with implementations described herein.

Like reference symbols in the various drawings indicate like elements.

### DETAILED DESCRIPTION

This document describes a wireless wide area network (WWAN) radio that can be implemented as a system or a device. Examples of a WWAN and WWAN radio are described in U.S. patent application Ser. No. 18/102,491, filed Jan. 27, 2023, which is a continuation of U.S. patent application Ser. No. 16/183,071, which itself is a continuation of application Ser. No. 15/984,350 (claiming priority to Prov. Application No. 62/508,906), all of which are incorporated by reference herein for all purposes.

The present disclosure describes a system and method for wireless inter-networking between a wireless wide area network (WWAN) and a local area network (WLAN) employing one or more extended range wireless inter-networking devices. More specifically, a high-powered wireless interconnect device is described that includes high efficiency circuitry to make it possible to implement in a fixed, in-building, portable, or in-vehicle form factor, and which provides reasonable battery life, size, weight, and thermal dissipation.

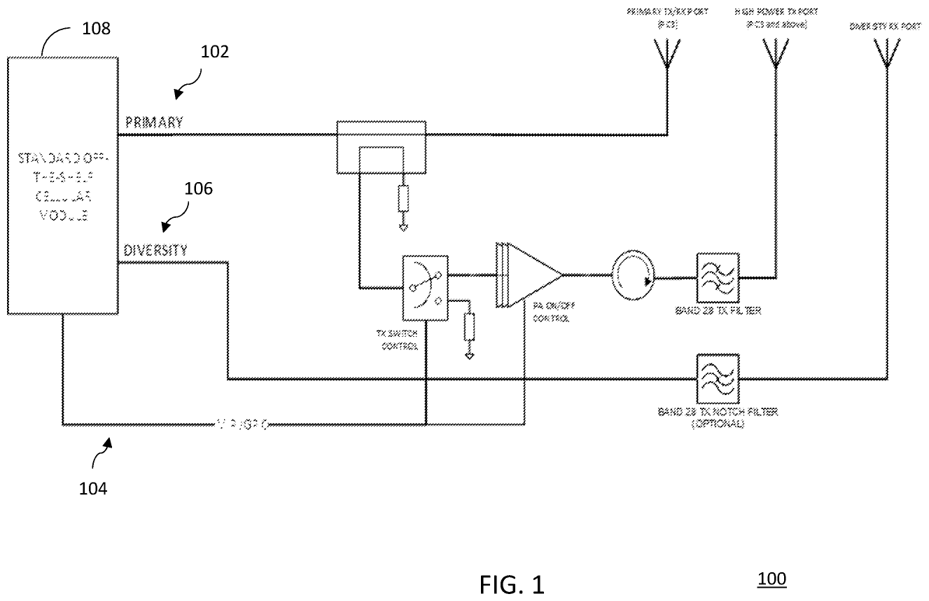

In some implementations, a WWAN radio 100, as shown in FIG. 1, does not need a duplex chain or duplexer. The WWAN radio includes a primary transmit/receive (TX/RX) port 102, a high-power TX port 104, and a diversity RX port 106. The diversity RX port 106 and high-power TX port 104 are controlled by a mobile industry processor interface (MIPI), and general purpose input/output signaling and communication control channel 108.

The WWAN radio 100 further includes a first WWAN transceiver/MODEM configured to communicate over one or more WWANs. The WWAN radio 100 further includes a standard (i.e. “primary”) power port 102 communicably coupled to the first WWAN transceiver/MODEM, and configured as the donor path for a coupled port including a standard power port antenna 112. The standard power port 102 is configured to transmit at a first maximum power level.

The WWAN radio 100 is further configured with the high-power port 104 communicably coupled to the standard power port 102 and configured to have a fixed gain value high power amplifier and a high power antenna 114. The high-power port 104/114 is configured to transmit at a second maximum power level that is greater than the first maximum power level.

Although a few embodiments have been described in detail above, other modifications are possible. Other embodiments may be within the scope of the following claims.

1. A wireless wide area network (WWAN) radio comprising:
a first WWAN transceiver/MODEM configured to communicate over one or more WWANs;
a standard power port communicably coupled to the first WWAN transceiver/MODEM, and configured as the donor path for a coupled port including a standard power port antenna, the standard power port configured to transmit at a first maximum power level; and
a high power port communicably coupled to the standard power port and configured to have a fixed gain value high power amplifier and a high power antenna, the high power port configured to transmit at a second maximum power level being greater than the first maximum power level.

2. The WWAN radio in accordance with claim 1, further comprising:
a second WWAN transceiver/MODEM configured to communicate over one or more WWANs;
a standard power port communicably coupled to the second WWAN transceiver/MODEM, and configured as the donor path for a coupled port including a standard power port antenna, the standard power port configured to transmit at a first maximum power level; and
a high power port communicably coupled to the standard power port and configured to have a fixed gain value high power amplifier and a high power antenna, the high power port configured to transmit at a second maximum power level being greater than the first maximum power level.

3. The WWAN radio in accordance with claim 1, further comprising:
a diversity receive port coupled to the first WWAN transceiver/MODEM.

4. The WWAN radio in accordance with claim 3, wherein the diversity receive port and the high-power port are controlled by a mobile industry processor interface (MIPI).
